(19) United States
(12) Patent Application Publication
(10) Pub. No.: US 2026/0128906 A1
(43) Pub. Date: May 7, 2026

(54) Tamper Proof Transmission of Commands

(71) Applicant: ServiceNow, Inc., Santa Clara, CA (US)

(72) Inventors: Benjamin Phan, San Diego, CA (US); Tyler Woodard, San Diego, CA (US); Nisan Bar Zion, San Diego, CA (US); Vamsee Lakamsani, Santa Clara, CA (US); Gary Stentiford, San Diego, CA (US)

(21) Appl. No.: 18/938,177

(22) Filed: Nov. 5, 2024

(51) Int. Cl. H04L 9/32; H04L 9/14

(52) U.S. Cl. CPC H04L 9/3247; H04L 9/14

(57) ABSTRACT

A method includes determining an instruction configured to cause an endpoint device to execute an operation. The method also includes determining a cryptographic signature based on the instruction, and generating an instruction payload that includes the instruction and the cryptographic signature. The method further includes transmitting the instruction payload to the endpoint device by way of a multi-party server. The instruction may be executable by the endpoint device when the cryptographic signature in the instruction payload is verified by the endpoint device based on the instruction in the instruction payload.

### BACKGROUND

An endpoint device in a network may be instructed to execute one or more operations. In some cases, the instruction to execute the operations may be transmitted to the endpoint device from and/or through computing resources that are shared by multiple entities. Accordingly, it may be desirable to protect the instruction from tampering by any of the entities that share the computing resources, thus preventing and/or reducing the likelihood of execution of malicious operations by the endpoint device.

### SUMMARY

A computational instance of a remote network management platform may be configured to transmit an instruction to an endpoint device by way of a multi-party server. The remote network management platform may use the multi-party server to, for example, allow a large number of endpoint devices to quickly and efficiently access computational resources provided by the remote network management platform, among other reasons. Instructions transmitted by the computational instance may cause endpoint devices of a network to execute operations that allow the computational instance to, for example, monitor and/or control the endpoint devices. The multi-party server may be shared by multiple networks, each of which may be associated with a corresponding computational instance of the remote network management platform. In order to prevent a computing device in one network from tampering with the instructions transmitted through the multi-party server to endpoint devices in other networks, the instructions may be secured using various cryptographic operations.

Specifically, the computational instance may be configured to determine a first cryptographic signature (e.g., using a private key of the computational instance) based on the instruction. The instruction and the first cryptographic signature may be combined to form an instruction payload, which the computational instance may transmit to the endpoint device by way of the multi-party server. Based on and/or in response to reception of the instruction payload from the multi-party server, the endpoint device may be configured to verify the first cryptographic signature in the instruction payload.

For example, the endpoint device may be configured to determine a second cryptographic signature (e.g., using a public key corresponding to the private key) based on the instruction in the instruction payload, and compare the second cryptographic signature to the first cryptographic signature in the instruction payload. The endpoint device may be configured to execute the instruction in the instruction payload when the second cryptographic signature matches (e.g., is equal to) the first cryptographic signature. When the second cryptographic signature does not match the first cryptographic signature, the endpoint device may be configured to refuse to execute the instruction. Thus, unauthorized modification of the instruction payload at the multi-party server (and elsewhere) may cause a mismatch in the second cryptographic signature and the first cryptographic signature, which may signal to the endpoint device that the instruction may have been tampered with and is therefore not safe for execution.

Accordingly, a first example embodiment may involve determining an instruction configured to cause an endpoint device to execute an operation, and determining a cryptographic signature based on the instruction. The first example embodiment may also involve generating an instruction payload that includes the instruction and the cryptographic signature. The first example embodiment may further involve transmitting the instruction payload to the endpoint device by way of a multi-party server. The instruction may be executable by the endpoint device when the cryptographic signature in the instruction payload is verified by the endpoint device based on the instruction in the instruction payload.

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 illustrates a computing system, in accordance with example embodiments.

FIG. 7A illustrates a shared instruction list, in accordance with example embodiments.

FIG. 7B illustrates endpoint-specific instruction lists, in accordance with example embodiments.

FIG. 7C illustrates an endpoint-specific instruction payload, in accordance with example embodiments.

FIGS. 8A and 8B are message flow diagrams, in accordance with example embodiments.

FIG. 9 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client”and “server”components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved is how to detect unauthorized modification of instructions and prevent an endpoint device from executing instructions that have been tampered with at some point during transmission of the instructions from a computational instance to the endpoint device by way of a multi-party server device. In practice, this is problematic because execution, by the endpoint device, of instructions that have been tampered with may cause the endpoint device to perform malicious operations, at least some of which may be introduced, without authorization, by a party that utilizes the multi-party server device. Another technical problem being solved is how to create instruction payloads that are both modular and cryptographically secured. In practice, this is problematic because, once an instruction payload is cryptographically signed, modification or rearrangement of the instruction payload may affect the validity of the cryptographic signature.

In other techniques, the multi-party server device might be omitted, and the endpoint device may instead communicate directly with the computational instance. However, this arrangement does not allow the multi-party server device to be used to improve the accessibility and scalability of computing resources provided by computational instances. Additionally, in other techniques, cryptographic signatures may be generated in a manner that prevents modification and/or rearrangement of contents of the instruction payload once the instruction payload has been cryptographically signed. Thus, other techniques did little if anything to secure instruction payloads in the context of computing resources shared by multiple parties and/or provide payloads that are both modular and secure.

The embodiments herein overcome these limitations by (i) including, in the instruction payload, both a shared instruction list and endpoint-specific instruction lists, and (ii) cryptographically signing, at the computational instance, individual portions of these. In this manner, contents of an instruction payload may be rearranged without affecting the validity of the cryptographic signatures therein, and endpoint devices may verify the individual portions of instruction payloads in a more accurate, robust, and efficient fashion. This results in several advantages. First, computational instances may generate shared instruction payloads that include instructions for multiple endpoint devices, thereby avoiding redundant transmission of the same instructions (which reduces processor, memory, and network utilization). Second, the shared instruction payloads may be separated into different endpoint-specific instruction payloads by the multi-party server device, each of which may be routed to a different endpoint device, thereby avoiding transmission of irrelevant data to some endpoint devices (which also reduces processor, memory, and network utilization). Third, each endpoint device may verify the cryptographic signature(s) contained in the endpoint-specific instruction payload provided thereto by the multi-party server device, thus allowing the respective endpoint device to detect and refuse execution of instructions that have been tampered with.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or eXtensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-based Computing Environments

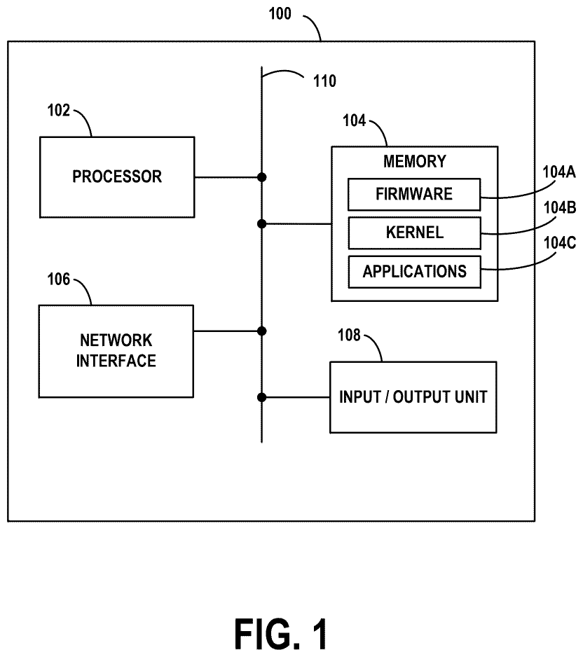

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/ output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

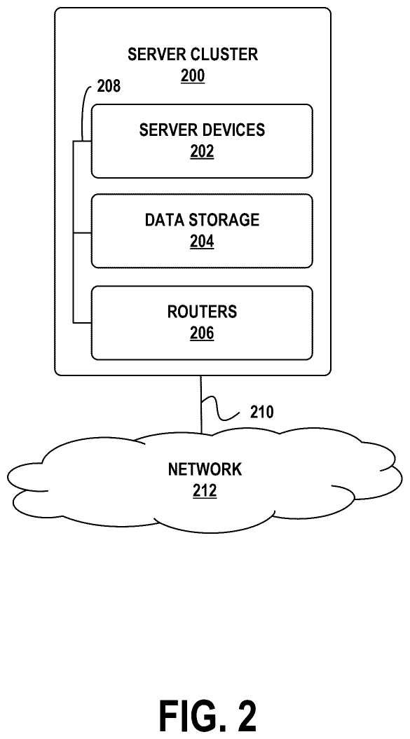

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

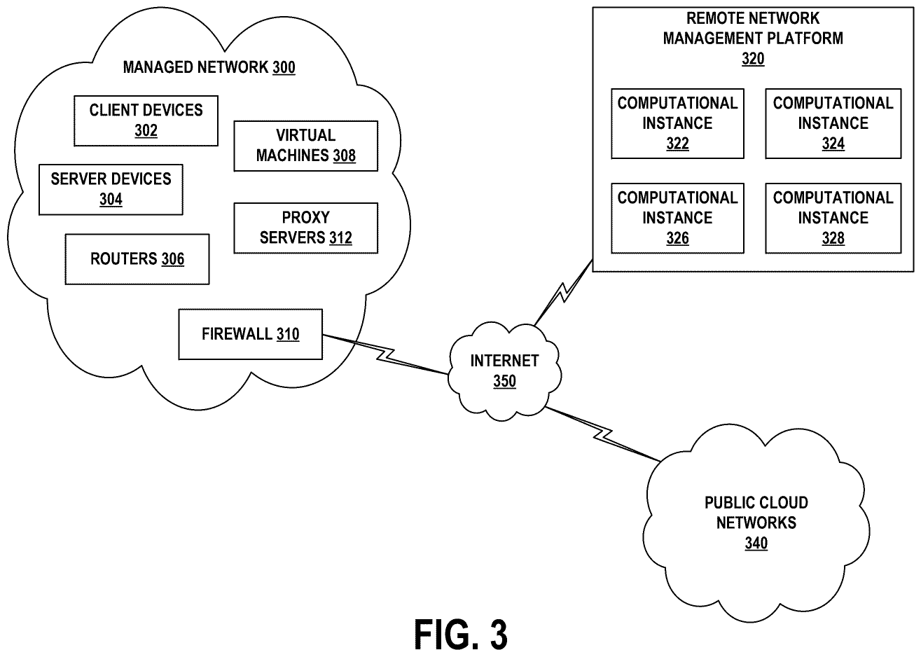

FIG. 3 depicts a remote network management architecture, in accordance with example embodiments. This architecture includes three main components - managed network 300, remote network management platform 320, and public cloud networks 340 - all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

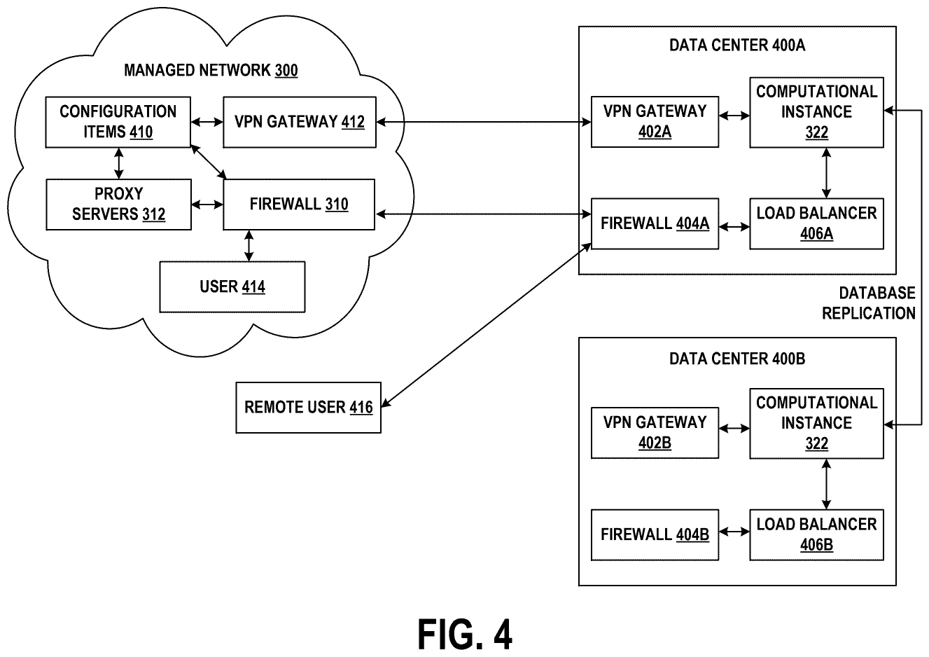

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

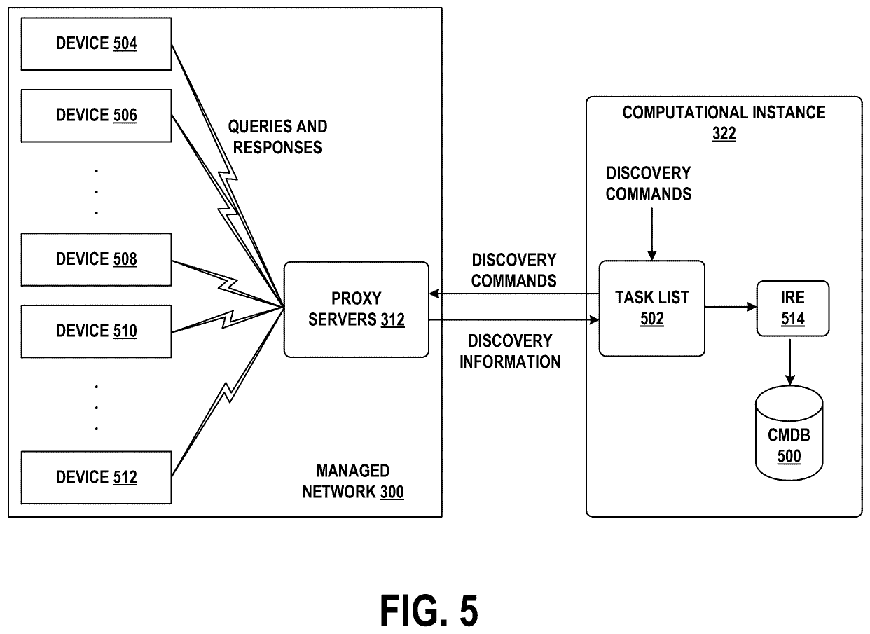

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases—under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices - for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Example System

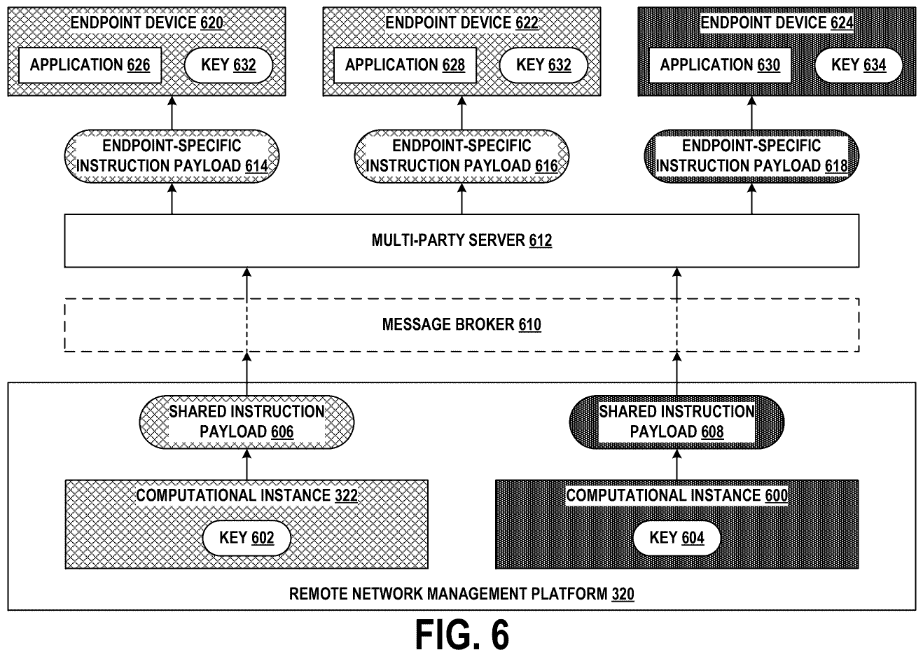

FIG. 6 illustrates an example system that includes remote network management platform 320, message broker 610, multi-party server 612, endpoint device 620, endpoint device 622, and endpoint device 624. Remote network management platform 320 may include computational instance 322 and computational instance 600, among other computational instances (not shown). In some implementations, multi-party server 612 and/or message broker 610 may form part of and/or may be provided by remote network management platform 320. In other implementations, multi-party server 612 and/or message broker 610 may be provided by one or more other computing systems (e.g., a third-party computing system) on behalf of remote network management platform 320.

Endpoint devices 620, 622, and 624 (“endpoint devices 620-624”) may form part of and/or may be provided by one or more managed networks. For example, endpoint devices 620 and 622 may form part of a first managed network that is associated with computational instance 322, as indicated by the first fill pattern thereof, and endpoint device 624 may form part of a second managed network that is associated with computational instance 600, as indicated by the second fill pattern thereof. Endpoint devices 620-624 may represent computing devices of various types and/or form factors, such as desktop computers, laptop computers, tablet computers, cellular telephones, and/or wearable devices, among others. Endpoint devices 620-624 may alternatively be referred to as agents, agent devices, clients, and/or client devices, among other possibilities.

Endpoint devices 620-624 and/or other computing devices may be configured to communicate with remote network management platform 320 to utilize the computing resources provided thereby. Additionally, remote network management platform 320 may be configured to communicate with endpoint devices 620-624 to control aspects of the operations thereof. In some cases, transmission of such communications directly between endpoint devices 620-624 and remote network management platform 320 may strain the ability of remote network management platform 320 to handle the communications and/or provide the requested computing resources. For example, when a large number of requests is received by computational instance 322 during a relatively short period of time (e.g., during peak usage times), the amount of computing resources dedicated to computational instance 322 may be increased to handle these requests. If the amount of computing resources is not subsequently decreased, the computational resources of computational instance 322 may be underutilized during other times (e.g., outside of peak usage times).

Such allocation and deallocation of computing resources may be more difficult in cases where each computational instance of remote network management platform 320 is a single-party computational instance that is dedicated to a single party (rather than shared by multiple parties). Specifically, for single-party computational instances, the idle computing resources of a first party might not easily be usable by a second party that is experiencing increased computational load, since these idle computing resources may contain data of the first party that should not be accessible to the second party. Thus, in order to allow for better scaling, allocation, and/or utilization of the computational resources of remote network management platform 320, endpoint devices 620-624 may be configured to utilize multi-party server 612 and, in some cases, message broker 610. A single-party computational instance may alternatively be referred to as a single-tenant computational instance, and a multi-party server may alternatively be referred to as a multi-tenant server.

Multi-party server 612 may be accessible by multiple different parties. For example, the respective activities of the multiple different parties may be isolated from one another using software, but may be executed using shared hardware. Deployment of additional hardware for the multiple different parties (e.g., deploying additional instantiations of multi-party server 612) and/or allocation of additional software resources for individual parties may be easier than adjusting the amount of computing resources provided for individual computational instances of remote network management platform 320. Thus, multi-party server 612 may improve the availability, accessibility, and/or scalability of computational instances of remote network management platform 320.

In some cases, multi-party server 612 may include and/or may be implemented using a container orchestration system such as KUBERNETES, AMAZON ELASTIC CONTAINER SERVICE, DOCKER SWARM, HASHICORP Nomad, RED HAT OPENSHIFT, and/or SUSE RANCHER, among other possibilities. Thus, each party may be assigned one or more nodes, pods, and/or containers. The nodes, pods, and/or containers of a given party may be inaccessible to other parties that use multi-party server 612. The amount of computing resources dedicated to a given party may be increased by deploying additional nodes, pods, and/or containers, and may be decreased by deallocating nodes, pods, and/or containers. The amount of computing resources collectively dedicated to the multiple parties may be increased by deploying additional copies of multi-party server 612 on which additional nodes, pods, and/or containers can be deployed.

Message broker 610 may allow for asynchronous communication between endpoint devices 620-624 and remote network management platform 320 and/or between multi-party server 612 and remote network management platform 320. As one example, communications transmitted from endpoint devices 620 and 622 to computational instance 322 may be stored in a first message queue, and computational instance 322 may be able to obtain one or more messages from the first message queue once sufficient computational resources are available on computational instance 322 for processing these messages (rather than having to receive and process these messages synchronously as they are sent by endpoint devices 620 and 622).

As another example, communications transmitted from computational instance 600 to multi-party server 612 may be stored in a second message queue, and multi-party server 612 may be able to obtain one or more messages from the second message queue once sufficient computational resources are available on multi-party server 612 for processing these messages (rather than having to receive and process these messages synchronously as they are sent by computational instance 600). Thus, message broker 610 may allow endpoint devices 620-624, multi-party server 612, and/or remote network management platform 320 to expend computing resources on communicating with one another when such computing resources are available and not otherwise dedicated to other tasks (e.g., tasks with higher priorities).

The computational instances of remote network management platform 320 may be configured to transmit instruction payloads to endpoint devices 620-624. Such instruction payloads may allow the computational instances to control and/or monitor endpoint devices 620-624. For example, the instruction payloads may allow the computational instances to perform discovery operations with respect to (e.g., obtain information about) endpoint devices 620-624, update aspects of endpoint devices 620-624, and/or cause endpoint devices 620-624 to execute various operations (e.g., operating system shell functions, scripts, plug-ins, etc.), among other possibilities. Thus, the computational instances may be able to manage aspects of the different networks that utilize remote network management platform 320.

Execution of the operations in the instruction payloads may be facilitated and/or performed using a software application installed on each of endpoint devices 620-624. Specifically, endpoint device 620 may include application 626, endpoint device 622 may include application 628, and endpoint device 624 may include application 630 (“applications 626-630”). Each of applications 626-630 may be alternatively referred to as an agent client collector (ACC) and/or a monitoring application, among other possibilities. Applications 626-630 may represent native applications installed on endpoint devices 620-624 and/or web browser plugins installed in web browsers of endpoint devices 620-624, among other possibilities.

In the absence of multi-party server 612, instruction payloads may be transmitted directly between each of endpoint devices 620-624 and corresponding (single-party) computational instances of remote network management platform 320. That is, the instruction payloads might not move through computing resources shared by and/or dedicated to multiple parties, which may prevent and/or reduce the likelihood of tampering with the instruction payloads. When multi-party server 612 is used, the instruction payloads may move through computing resources that are shared by multiple parties (i.e., through multi-party server 612), thus creating the possibility that a first party might attempt to tamper with the payloads of a second party. Such tampering may be difficult due to security measures implemented by multi-party server 612, but may nonetheless be possible in some circumstances.

Accordingly, to prevent and/or reduce the likelihood of such tampering, instruction payloads transmitted from computational instances of remote network management platform 320 through multi-party server 612 to endpoint devices 620-624 may be cryptographically secured. Specifically, each instruction payload transmitted by computational instances of remote network management platform 320 may be cryptographically signed, and the cryptographic signature may be included as part of the instruction payload. A given endpoint device of endpoint devices 620-624 may be configured to execute the operations in a corresponding instruction payload when a cryptographic signature determined by the given endpoint device based on contents of the instruction payload matches the cryptographic signature included in the instruction payload.

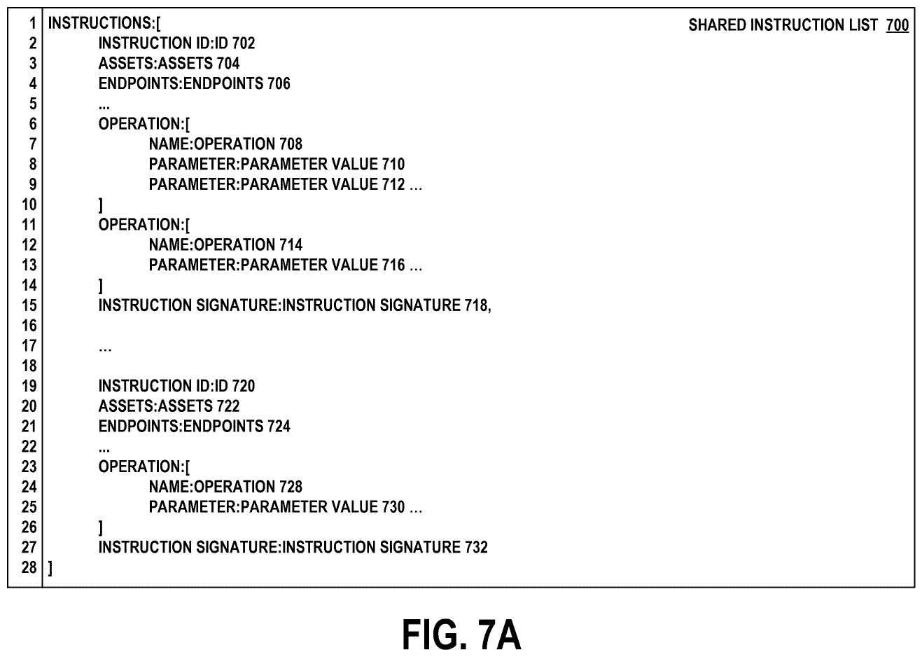

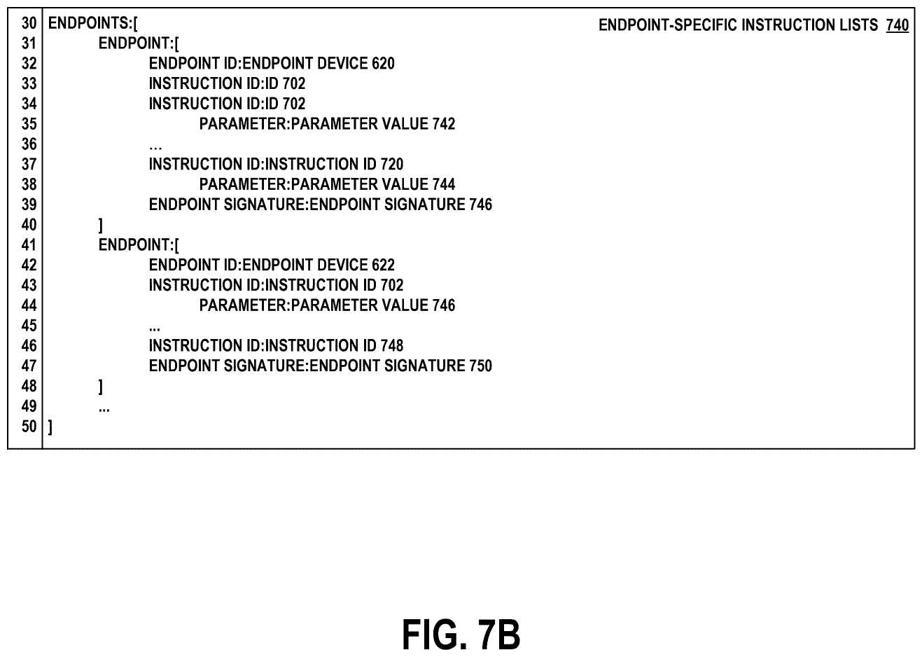

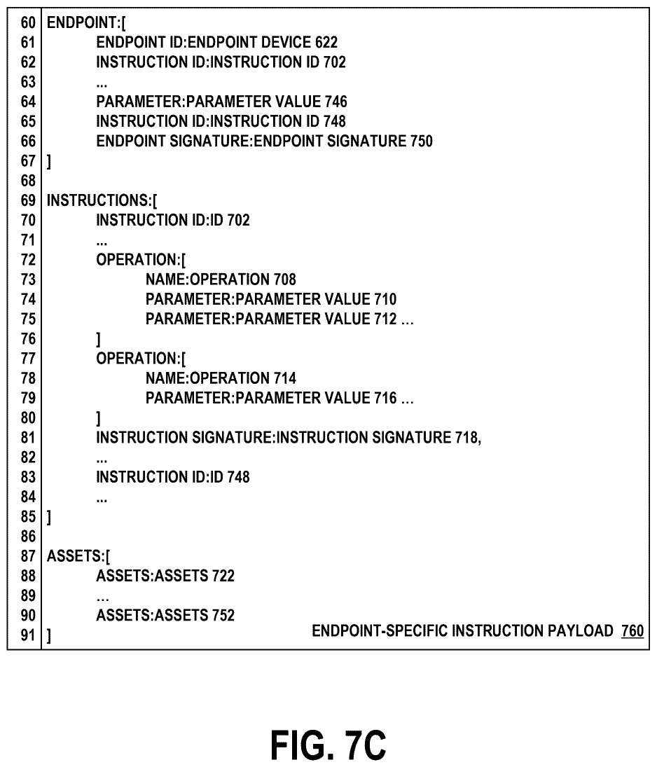

For example, computational instance 322 may be configured to (i) generate shared instruction payload 606 and (ii) sign one or more parts of shared instruction payload 606 using key 602 (e.g., using a private key of a first signing key pair). Shared instruction payload 606 may include a plurality of instructions, each of which may be configured to cause an endpoint device to execute corresponding operation(s). The instructions in shared instruction payload 606 may be separable by multi-party server 612 to generate endpoint-specific instruction payload 614 for endpoint device 620 and endpoint-specific instruction payload 616 for endpoint device 622. Specifically, each instruction of the plurality of instructions in shared instruction payload 606 may be individually signed, thus allowing multi-party server 612 to route each instruction to a different endpoint device without affecting the validity of the cryptographic signatures. An example shared instruction payload is illustrated in and discussed with respect to FIGS. 7A and 7B. An example endpoint-specific instruction payload is illustrated in and discussed with respect to FIG. 7C.

As one example, shared instruction payload 606 may include a first instruction for endpoint device 620, and shared instruction payload 606 and endpoint-specific instruction payload 614 may each include a first cryptographic signature generated by computational instance 322 based on the first instruction. Based on and/or in response to reception of endpoint-specific instruction payload 614, application 626 of endpoint device 620 may be configured to use key 632 (e.g., a public key of the first signing key pair) to generate a second cryptographic signature based on a corresponding portion (representing the first instruction) of endpoint-specific instruction payload 614. Computational instance 322 may generate the first cryptographic signature and application 626 may generated the second cryptographic signature based on content(s) of the same portion of shared instruction payload 606.

Thus, when neither endpoint-specific instruction payload 614 nor shared instruction payload 606 has been tampered with after being signed by computational instance 322, the second cryptographic signature will match the first cryptographic signature as generated by computational instance 322 (based on the corresponding portion of shared instruction payload 606) and included in each of shared instruction payload 606 and endpoint-specific instruction payload 614. Application 626 and/or endpoint device 620 may be configured to execute the first instruction in endpoint-specific instruction payload 614 when the second cryptographic signature matches the first cryptographic signature contained in endpoint-specific instruction payload 614 (i.e., when endpoint-specific instruction payload 614 has not been tampered with and thus includes the first instruction as generated by computational instance 322).

As another example, shared instruction payload 606 may also include a second instruction for endpoint device 622, and shared instruction payload 606 and endpoint-specific instruction payload 616 may each include a third cryptographic signature generated by computational instance 322 based on the second instruction. Based on and/or in response to reception of endpoint-specific instruction payload 616, application 628 of endpoint device 622 may be configured to use key 632 to generate a fourth cryptographic signature based on a corresponding portion (representing the second instruction) of endpoint-specific instruction payload 616. Computational instance 322 may generate the third cryptographic signature and application 628 may generate the fourth cryptographic signature based on content(s) of the same portion of shared instruction payload 606.

Thus, when neither endpoint-specific instruction payload 616 nor shared instruction payload 606 has been tampered with after being signed by computational instance 322, the fourth cryptographic signature will match the third cryptographic signature as generated by computational instance 322 (based on the corresponding portion of shared instruction payload 606) and included in each of shared instruction payload 606 and endpoint-specific instruction payload 616. Application 628 and/or endpoint device 622 may be configured to execute the second instruction in endpoint-specific instruction payload 616 when the fourth cryptographic signature matches the third cryptographic signature contained in endpoint-specific instruction payload 616 (i.e., when endpoint-specific instruction payload 616 has not been tampered with and thus includes the second instruction as generated by computational instance 322).

Computational instance 600 may be configured to (i) generate shared instruction payload 608 and (ii) sign one or more parts of shared instruction payload 608 using key 604 (e.g., using a private key of a second signing key pair). Shared instruction payload 608 may include one or more instructions, at least some of which may be configured to cause endpoint device 624 to execute corresponding operation(s). When shared instruction payload 608 includes instructions for multiple different endpoint devices (rather than instructions for only endpoint device 624), shared instruction payload 608 may be separable by multi-party server 612 to generate endpoint-specific instruction payload 618 for endpoint device 624 and one or more other endpoint-specific instruction payloads for one or more other endpoint devices. When shared instruction payload 608 includes instructions for only one endpoint device (e.g., endpoint device 624), endpoint-specific instruction payload 618 may represent a reformatted version of shared instruction payload 608. Each instruction of the plurality of instructions in shared instruction payload 608 may be individually signed, thus allowing multi-party server 612 to route and/or reformat shared instruction payload 608 without affecting the validity of the cryptographic signatures.

Shared instruction payload 606 may include a third instruction for endpoint device 624, and shared instruction payload 608 and endpoint-specific instruction payload 618 may each include a fifth cryptographic signature generated by computational instance 600 based on the third instruction. Based on and/or in response to reception of endpoint-specific instruction payload 618, application 630 of endpoint device 624 may be configured to use key 634 (e.g., a public key of the second signing key pair) to generate a sixth cryptographic signature based on a corresponding portion (representing the third instruction) of endpoint-specific instruction payload 618. Computational instance 600 may generate the fifth cryptographic signature and application 630 may generate the sixth cryptographic signature based on content(s) of the same portion of shared instruction payload 608.

Thus, when neither endpoint-specific instruction payload 618 nor shared instruction payload 608 has been tampered with after being signed by computational instance 600, the sixth cryptographic signature will match the fifth cryptographic signature as generated by computational instance 600 (based on the corresponding portion of shared instruction payload 608) and included in each of shared instruction payload 608 and endpoint-specific instruction payload 618. Application 630 and/or endpoint device 624 may be configured to execute the third instruction in endpoint-specific instruction payload 618 when the sixth cryptographic signature matches the fifth cryptographic signature contained in endpoint-specific instruction payload 618 (i.e., when endpoint-specific instruction payload 618 has not been tampered with and thus includes the third instruction as generated by computational instance 600).

Key 632 may be a public key corresponding to key 602, which may be a private key. Similarly, key 634 may be a public key corresponding to key 604, which may be a private key. Thus, key 632 and key 602 may form a first (asymmetric) signing key pair, and key 634 and key 604 may form a second (asymmetric) signing key pair. Key 602 may differ from key 604, and key 632 may differ from key 634, so that endpoint devices in different managed networks do not share the same cryptographic keys. In some implementations, all endpoint devices of a given managed network may share the same public key. In other implementations, some endpoint devices of a given managed network may use a different signing key pair than other endpoint devices of the given managed network, and computational instance 322 may thus include multiple different private keys. For example, each endpoint device of the given managed network may use a device-specific public key, and the corresponding computational instance may thus include multiple corresponding private keys.

Each respective application of applications 626, 628, and 630 may be configured to obtain the corresponding public key directly from the corresponding computational instance without the corresponding public key being transmitted through multi-party server 612, thus preventing and/or reducing the likelihood of the corresponding public key being intercepted and/or replaced by computing devices in managed networks other than the managed network of which the respective endpoint device is part. For example, application 626 may be configured to obtain key 632 directly from computational instance 322 without key 632 being transmitted through multi-party server 612, thus preventing and/or reducing the likelihood of key 632 being intercepted and/or replaced by, for example, endpoint device 624. Similarly, application 630 may be configured to obtain key 634 directly from computational instance 600 without key 634 being transmitted through multi-party server 612. Thus, keys 632 and 634 may be transmitted in a different manner than shared instruction payloads 606 and 608 and/or endpoint-specific instruction payloads 614, 616, and 618 to further improve security of the system.

### VIII. Example Instruction Payloads

FIGS. 7A and 7B illustrate example contents of a shared instruction payload. FIG. 7C illustrates example contents of an endpoint-specific instruction payload. Specifically, FIG. 7A illustrates shared instruction list 700 that includes a plurality of instructions that are assigned for execution by one or more endpoint devices. Shared instruction list 700 spans lines 1-28 of FIG. 7A. Shared instruction list 700 may include multiple instruction blocks (i.e., contained within Instructions: [ . . . ] on lines 1-28). For example, a first instruction block is shown on lines 2-15 of shared instruction list 700 and a second instruction block is shown on lines 19-27 of shared instruction list 700. In some cases, shared instruction list 700 may include additional instruction blocks, as indicated by the ellipsis on line 17. Lines 16 and 18 are blank for clarity of illustration. Any variables and/or values shown in shared instruction list 700 may be referred to herein as “shared” (rather than endpoint-specific) since different parts of shared instruction list 700 may be intended for multiple different endpoints and thus shared thereby.

Each instruction block may contain one or more operations to be performed by corresponding one or more endpoint devices. Dividing shared instruction list 700 into instruction blocks may allow multi-party server 612 to route different instruction blocks to different endpoint devices, thus reducing the sizes of the endpoint-specific instruction payloads by omitting therefrom instructions that are irrelevant for (i.e., not assigned to) a given endpoint device. Accordingly, each endpoint device may obtain the instruction blocks assigned thereto, but might not obtain instruction blocks that are not assigned thereto (but that may be assigned to other endpoint devices).

Each respective instruction block may include an instruction identifier (“instruction ID”), an assets list, an endpoints list, an operation list, and an instruction signature. The instruction identifier of a respective instruction block may uniquely identify the respective instruction block to distinguish it from other instruction blocks (e.g., within the context of a shared instruction payload and/or within the context of all instruction blocks that could be generated by a computational instance). The assets list may represent any applications, plug-ins, operating system functions, and/or other software involved in and/or needed for execution of the operations in the respective instruction block. The endpoints list may include one or more endpoint devices for which the respective instruction block is intended and by which the operations in the respective instruction block are to be executed. Thus, a respective operation block may be executable by multiple endpoint devices, and multi-party server 612 may route the respective operation block to each of the multiple endpoint devices. The operation list may specify the operations to be executed by the endpoint devices in the endpoints list. The instruction signature may be a cryptographic signature generated (e.g., using a private key of the computational instance) based on the part of the instruction block that is (i) intended to be protected from tampering and (ii) part of both the shared instruction payload and the corresponding endpoint-specific instruction payload.

The first instruction block on lines 2-15 may include an instruction ID having a value of ID 702 on line 2, an asset list having a value of assets 704 on line 3, an endpoints list having a value of endpoints 706 on line 4, an operation list on lines 6-14, and an instruction signature having a value of instruction signature 718 on line 15. The second instruction block on lines 19-27 may include an instruction ID having a value of ID 720 on line 19, an asset list having a value of assets 722 on line 20, an endpoints list having a value of endpoints 724 on line 21, an operation list on lines 23-26, and an instruction signature having a value of instruction signature 732 on line 27. Each instruction block may additionally include other information not explicitly shown herein, as indicated by the ellipses on lines 5 and 22. In other implementations, the information shown in FIGS. 7A and 7B may be rearranged (e.g., reordered) and/or reformatted (e.g., expressed using different programming languages or data formats) in various ways.

As an example, when shared instruction list 700 is part of shared instruction payload 606, line 4 may indicate, for example, that the information in lines 2-15 is to be provided to (and the operations indicated by lines 6-14 are to be executed by) each of endpoint devices 620 and 622 (i.e., endpoints 706 may specify endpoint devices 620 and 622 using, for example, their unique alphanumeric names, IP addresses, and/or other identifiers). Line 21 may indicate, for example, that the information in lines 19-27 is to be provided to (and the operations indicated by lines 23-26 are to be executed by) endpoint device 620 but not endpoint device 622 (i.e., endpoints 724 may specify endpoint device 620 but not endpoint device 622).

The operation list of a respective instruction block may include one or more operations. Each respective operation in the operation list may include (i) a name of the respective operation (e.g., an alphanumeric string that may uniquely identify the respective operation) and (ii) one or more parameters for the respective operation. The one or more parameters may include input(s) for the respective operation, execution mode(s) of the respective operation, and/or any other values that may affect execution of the respective operation. A given operation in the operation list may invoke and/or rely on functions provided by an operating system of an endpoint device and/or function provided by a software application (e.g., native application, web browser plug-in, etc.) installed on the endpoint device, among other possibilities.

The operation list of the first instruction block may include a first operation on lines 6-10 and a second operation on lines 11-14. The first operation may be named operation 708 as indicated on line 7, and may be executed using parameter value 710 as indicated on line 8 and parameter value 712 as indicated on line 9. The second operation may be named operation 714 as indicated on line 12, and may be executed using parameter value 716 as indicated on line 13. The operation list of the second instruction block may include a third operation on lines 23-26. The third operation may be named operation 728 as indicated on line 24, and may be executed using parameter value 730 as indicated on line 25. In some implementations, operations 708, 714, and/or 728 may be executed using additional parameter values, as indicated by the ellipses on lines 9, 13, and 25.

Instruction signature 718 may be generated by signing lines 6-14 using key 602. Instruction signature 732 may be generated by signing lines 23-26 using key 602. Thus, for example, the instruction signature of a respective instruction block may be based exclusively on the operation list of the respective instruction block, thus protecting the operation list from tampering. Generating a corresponding instruction signature for each respective instruction block (rather than generating a single cryptographic signature for shared instruction list 700 as a whole) may allow the instruction blocks of shared instruction list 700 to be separated and routed to corresponding endpoint devices by multi-party server 612 without compromising the integrity of the instruction signatures.

For example, since instruction signature 718 of the first instruction block (lines 2-15) depends on content of the first instruction block, but does not depend on the contents of any other instruction block (e.g., the second instruction block on lines 19-27) in shared instruction list 700, the contents of the first instruction block may be verified by a given endpoint device based on the first instruction block and without dependence on any other instruction block in shared instruction list 700 (some of which might not be provided to the given endpoint device). Similarly, since instruction signature 732 of the second instruction block (lines 19-27) depends on content of the second instruction block, but does not depend on the contents of any other instruction block (e.g., the first instruction block on lines 2-15) in shared instruction list 700, the contents of the second instruction block may be verified by a particular endpoint device based on the second instruction block and without dependence on any other instruction block in shared instruction list 700 (some of which might not be provided to the particular endpoint device).

In other implementations, instruction signature 718 may additionally be based on one or more other lines (e.g., one or more of lines 2-5) of the first instruction block, and instruction signature 732 may be based on one or more other lines (e.g., one or more of lines 19-22) of the second instruction block, as long as the one or more other lines of the given instruction block are provided to a given endpoint device by multi-party server 612 as part of a corresponding endpoint-specific instruction payload. Thus, in general, instruction signature 718 may be generated by signing, using key 602, (i) lines 6-14 and (ii) any other lines of lines 2-5 that are provided to endpoint devices 620 and 622 (as part of endpoint-specific instruction payloads 614 and 616, respectively) by multi-party server 612, and instruction signature 732 may be based on signing, using key 602, (i) lines 23-26 and (ii) any other lines of lines 19-22 that are provided to endpoint device 620 (as part of endpoint-specific instruction payload 614) by multi-party server 612.

FIG. 7B illustrates endpoint-specific instruction lists 740 that include, for each respective endpoint device for which shared instruction list 700 contains instructions, a corresponding endpoint-specific instruction list. Endpoint-specific instruction lists 740 span lines 30-50 of FIG. 7B, and are contained within the Endpoints: [ . . . ] block. Endpoint-specific instruction lists 740 may include a first endpoint-specific instruction list on lines 31-40 and a second endpoint-specific instruction list on lines 41-48.

Each respective endpoint-specific instruction list may include a corresponding endpoint identifier (“Endpoint ID”), corresponding instruction identifier(s), corresponding parameter(s), and a corresponding endpoint signature. The endpoint identifier may represent the endpoint to which the respective endpoint-specific instruction list corresponds and by which instruction(s) specified in the respective endpoint-specific instruction list are to be executed. The instruction identifier(s) may specify the instruction(s) to be executed by the respective endpoint device. The parameter(s) provided as part of endpoint-specific instruction lists 740 may be analogous to the parameters provided as part of shared instruction list 700. The parameter(s) provided as part of endpoint-specific instruction lists 740 may be used in addition to and/or may override at least some of the parameters provided as part of shared instruction list 700. The endpoint signature may be a cryptographic signature generated based on the contents of the respective endpoint-specific instruction list.

The first endpoint-specific instruction list (lines 31-40) may indicate on line 32 that this list is intended for endpoint device 620, and may include (i) an instruction identifier having a value of ID 702 on line 33, (ii) an instruction identifier having a value of ID 702 on line 34, (iii) a parameter having a value of parameter value 742 on line 35, (iv) an instruction identifier having a value of ID 720 on line 37, (v) a parameter having a value of parameter value 744 on line 38, and (vi) an endpoint signature having a value of endpoint signature 746 on line 39.

Line 33 may indicate that endpoint device 620 is commanded to execute the operations in the first instruction block (denoted using ID 702) of shared instruction list 700 using the parameter values specified in the first instruction block. Line 34 may indicate that endpoint device is also commanded to execute the operations in the first instruction block of shared instruction list 700 using the parameter value 742, as indicated on line 35. If parameter value 742 corresponds to a parameter that is already specified as part of the first instruction block, parameter value 742 may override the value in the first instruction block. If parameter value 742 corresponds to a parameter that is not already specified as part of the first instruction block, parameter value 742 may be used in addition to any parameter values specified in the first instruction block. Thus, a given endpoint-specific instruction list may include multiple copies of an identifier of a particular instruction, each of which may be executed using a different set of one or more parameter values and may thus produce different output(s). Line 37 may indicate that endpoint device is further commanded to execute the operations in the second instruction block (denoted using ID 720) of shared instruction list 700 using the parameter value 744 (which may be used instead of or in addition to any parameter values specified as part of shared instruction list 700), as indicated on line 38.

Endpoint signature 746 may be generated by signing lines 32-38 using key 602. Endpoint signature 750 may be generated by signing lines 42-46 using key 602. Thus, for example, the endpoint signature of a respective endpoint-specific instruction list may be based exclusively on the content of the endpoint-specific instruction list, thus protecting the endpoint-specific instruction from tampering. Generating a corresponding endpoint signature for each respective endpoint-specific instruction list (rather than generating a single cryptographic signature for endpoint-specific instruction lists 740 as a whole) may allow the different endpoint-specific instruction lists to be separated and routed to corresponding endpoint devices by multi-party server 612 without compromising the integrity of the cryptographic signatures. Each endpoint-specific instruction list may include other instructions and/or parameters as indicated by the ellipses on lines 36 and 45.

In the example discussed above, both the instruction signatures and the endpoint signatures may be generated by a given computational instance using the same private key. In other implementations, the given computational instance may use an instruction key to sign the instruction blocks and an endpoint key to sign the endpoint blocks, with the instruction key being different from the endpoint key. Using an instruction key that differs from the endpoint key may provide an additional layer of security in the transmission and execution of instructions. The cryptographic signatures discussed in connection with FIG. 6 may include the instruction signatures and/or the endpoint signatures shown in FIGS. 7A and 7B.

FIG. 7C illustrates endpoint-specific instruction payload 760. Endpoint-specific instruction payload 760 may be intended for endpoint device 622 and may thus correspond to endpoint-specific instruction payload 616. Endpoint-specific instruction payload 760 may include an endpoint block (i.e., Endpoints: [ . . . ]) that spans lines 60-67, an instructions block (i.e., Instructions [ . . . ]) that spans lines 69-85, and an assets block (i.e., Assets [ . . . ]) that spans lines 87-91.

Endpoint-specific instruction payload 760 may include portions of shared instruction list 700 and endpoint-specific instruction lists 740 that are relevant and/or intended to be executed by endpoint device 622, and may omit portions thereof that are not relevant and/or intended to be executed by endpoint device 622. Accordingly, the endpoint block on lines 60-67 of FIG. 7C may include the endpoint-specific instruction list from lines 41-48 of FIG. 7B, and may omit other lines of FIG. 7B. The instruction block on lines 69-85 of FIG. 7C may include the first instruction block from lines 2-15 of FIG. 7A, and may omit the second instruction block from lines 19-27 of FIG. 7A. Generating endpoint-specific instruction payload 760 to include data that is relevant to endpoint device and omit data that is not relevant to endpoint device 622 may reduce a size of endpoint-specific instruction payload 760 without affecting the ability of endpoint device 622 to execute the instructions, thus reducing network bandwidth. Such modularity of endpoint-specific instruction payload 760 may be enabled and/or facilitated by signing individual instruction blocks of shared instruction list 700 (rather than singing shared instruction list 700 as a whole) and signing individual endpoint blocks of endpoint-specific instruction lists 740 (rather than signing endpoint-specific instruction lists 740 as a whole).

The endpoint block on lines 60-67 may include (i) endpoint signature 750 and (ii) all of the contents (e.g., lines 61-65) on which endpoint signature 750 is based. Thus, endpoint device 622 may be configured to use key 632 to generate a second endpoint signature based on lines 61-65 and determine whether the second endpoint signature matches endpoint signature 750. A mismatch between the second endpoint signature and endpoint signature 750 may indicate that the endpoint block on lines 60-67 may have been tampered with, and thus any instructions in endpoint-specific instruction payload 760 should not be executed. A match between the second endpoint signature and endpoint signature 750 may indicate that the endpoint block on lines 60-67 has not been tampered with, and thus any instructions in endpoint-specific instruction payload 760 may be executed provided that all other prerequisites to execution of the instructions are met.

The instructions block on lines 69-85 may include (i) instruction signature 718 and (ii) all of the contents (e.g., lines 72-80) on which instruction signature 718 is based. Thus, endpoint device 622 may be configured to use key 632 to generate a second instruction signature based on, for example, lines 72-80 and determine whether the second instruction signature matches instruction signature 718. A mismatch between the second instruction signature and instruction signature 718 may indicate that the part of the instructions block on lines 70-80 may have been tampered with, and thus the instruction with ID 702 should not be executed. A match between the second instruction signature and instruction signature 718 may indicate that the part of the instructions block on lines 70-80 has not been tampered with, and thus the instruction with ID 702 may be executed provided that all other prerequisites to execution of the instructions are met. The instructions block on lines 69-85 may also include commensurate information for the instruction with ID 748 (as indicated by the ellipsis on line 84), which may be used by endpoint device 622 to verify this instruction.

The assets block on lines 87-91 may include a list of one or more assets involved in executing the operations in the instruction block on lines 69-85. Specifically, the assets block on lines 87-91 may include assets 722 involved in execution of the instruction with ID 720 through assets 752 involved in execution of the instruction with ID 748. Including a separate assets block as part of endpoint-specific instruction payload 760 may allow duplicative assets initially specified in the instruction blocks of shared instruction list 700 to be consolidated, thereby reducing the size of endpoint-specific instruction payload 760.

Endpoint device 622 may be configured to execute the instruction with ID 702 when at least (i) the second endpoint signature matches endpoint signature 750 and (ii) the second instruction signature matches instruction signature 718. In some cases, endpoint device 622 may be configured to execute the instruction with ID 702 when, additionally, (iii) the endpoint block on lines 60-67 lists the instruction with ID 702 (indicating that the instruction with ID 702 is assigned to endpoint device 622 for execution) and/or (iv) the endpoints entry (if one is provided) of the instruction block on lines 70-81 lists endpoint device 622 (indicating that the instruction with ID 702 is assigned to endpoint device 622 for execution). Thus, in addition to checking that the contents of endpoint-specific instruction payload 760 have not been tampered with after generation by computational instance 322, endpoint device 622 may be configured to check that any instructions provided as part of endpoint-specific instruction payload 760 are in fact assigned to endpoint device 622 by computational instance 322 (e.g., rather than erroneously provided to endpoint device 622 by multi-party server 612).

In some implementations, one or more parts of endpoint-specific instruction payload 760 (as well as corresponding parts of shared instruction list 700 and/or endpoint-specific instruction lists 740) may be encrypted. The one or more parts of endpoint-specific instruction payload 760 may be encrypted using symmetric and/or asymmetric encryption. Thus, in addition to protecting the integrity of endpoint-specific instruction payload 760, shared instruction list 700, and/or endpoint-specific instruction lists 740 using cryptographic signatures, encryption of portions thereof may be used to make tampering yet more difficult, thus providing an additional layer of security. For example, rather than being transmitted as plaintext, lines 72-80 may be encrypted by computational instance 322 prior to transmission and decrypted by endpoint device 622 after reception.

### IX. Example Message Flow Diagrams

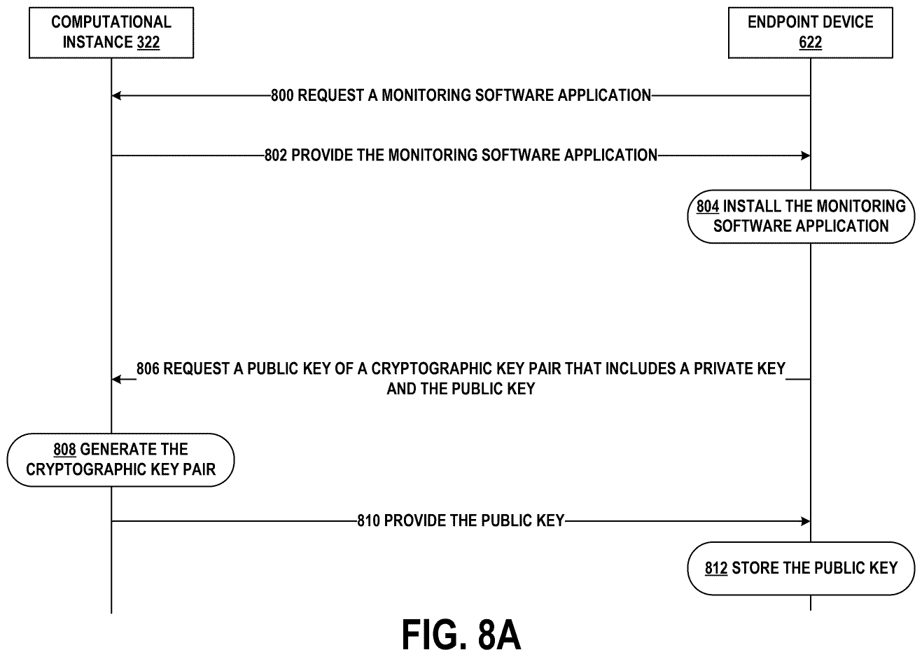

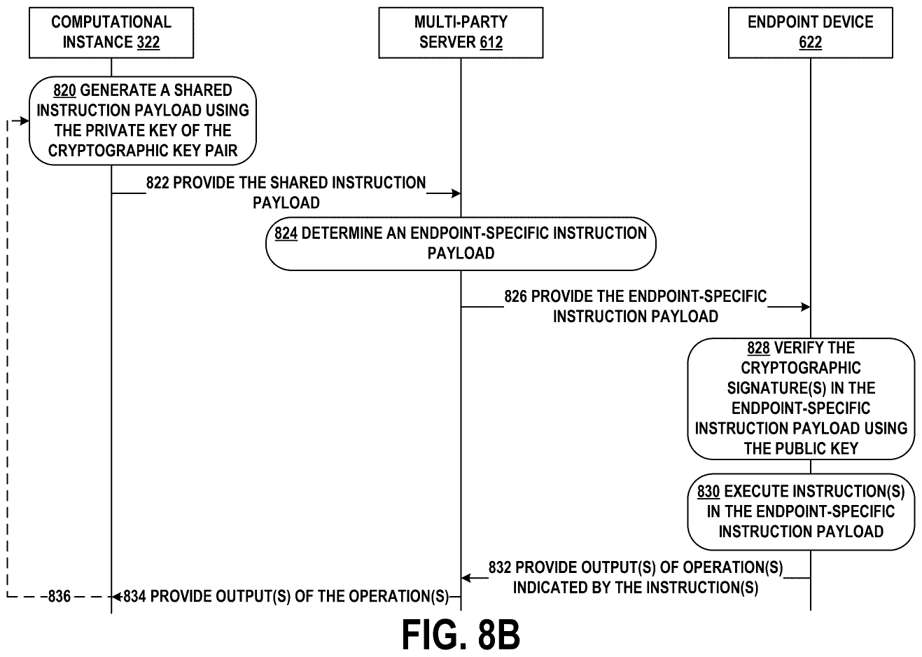

FIGS. 8A and 8B include message flow diagrams that illustrate example operations involved in generating, signing, and verifying instruction payloads. Endpoint device 622 may be configured to request, from computational instance 322, a monitoring software application, as indicated by arrow 800. The monitoring software application may correspond to application 628. Based on and/or in response to reception of the request at arrow 800, computational instance 322 may be configured to provide, to endpoint device 622, the monitoring software application, as indicated by arrow 802. Alternatively, computational instance 322 may be configured to provide, to endpoint device 622, the monitoring software application without endpoint device 622 requesting the monitoring software application. Based on and/or in response to reception of the monitoring software application at arrow 802, endpoint device 622 may be configured to install the monitoring software application, as indicated by block 804.

Endpoint device 622 may be configured to request, from computational instance 322, a public key of a cryptographic key pair that includes a private key and the public key (e.g., key 632), as indicated by arrow 806. The operations of arrow 806 may be performed and/or facilitated by the monitoring software application, possibly based on and/or in response to installation of the monitoring software application at block 804. Based on and/or in response to reception of the request at arrow 806, computational instance 322 may be configured to generate the cryptographic key pair, as indicated by block 808. Alternatively, in some cases, computational instance 322 may generate the cryptographic key pair at an earlier time before reception of the request at arrow 806.

Based on and/or in response to reception of the request at arrow 806 and/or generation of the cryptographic key pair at block 808, computational instance 322 may be configured to provide the public key to endpoint device 622, as indicated by arrow 810. Based on and/or in response to reception of the public key at arrow 810, endpoint device 622 may be configured to store the public key, as indicated by block 812. After installation of the monitoring software application and storage of the public key, endpoint device 622 may be configured to receive and verify instruction payloads from computational instance 322 via multi-party server 612.

Turning to FIG. 8B, computational instance 322 may be configured to generate a shared instruction payload using the private key of the cryptographic key pair, as indicated by block 820. Specifically, computational instance 322 may be configured to determine an instruction configured to cause endpoint device 622 to execute one or more operations and generate one or more cryptographic signatures of one or more parts of this instruction. For example, the shared instruction payload generated at block 820 may correspond to shared instruction payload 606 (as illustrated in and discussed with respect to FIG. 6), which may include shared instruction list 700 and endpoint-specific instruction list 740 (illustrated in and discussed with respect to FIGS. 7A and 7B, respectively). The shared instruction payload generated at block 820 may, in some cases, be referred to simply as an instruction payload (e.g., when it includes instructions for only one endpoint device).

Based on and/or in response to generation of the shared instruction payload at block 820, computational instance 322 may be configured to provide the shared instruction payload to multi-party server 612, as indicated by arrow 822. Based on and/or in response to reception of the instruction payload, multi-party server 612 may be configured to determine an endpoint-specific instruction payload for endpoint device 622, as indicated by block 824. In cases where the instruction payload at arrow 822 includes instructions for multiple different endpoint devices, multi-party server 612 may be configured to determine a plurality of endpoint-specific instruction payloads, including a corresponding endpoint-specific instruction payload for each of the multiple different endpoint devices. The endpoint-specific instruction payload generated at block 824 may correspond to, for example, endpoint-specific instruction payload 760 (as illustrated in and discussed with respect to FIG. 7C).

Based on and/or in response to determination of the endpoint-specific instruction payload at block 824, multi-party server 612 may be configured to provide the endpoint-specific instruction payload to endpoint device 622, as indicated by arrow 826. Based on and/or in response to reception of the endpoint-specific instruction payload at arrow 826, endpoint device 622 may be configured to verify, using the public key, the one or more cryptographic signatures in the endpoint-specific instruction payload. For example, endpoint device 622 may (i) determine one or more instruction signatures, (ii) verify that each of these one or more instruction signatures matches a corresponding instruction signature (e.g., instruction signature 718) in the endpoint-specific instruction payload, (iii) determine an endpoint signature, and (iv) verify that the endpoint signature matches a corresponding endpoint signature (e.g., endpoint signature 750) in the endpoint-specific instruction payload.

Based on and/or in response to verifying the one or more cryptographic signatures at block 828, endpoint device 620 may be configured to execute one or more instructions in the endpoint-specific instruction payload, as indicated by block 830. In some cases, a given instruction may be executed when endpoint device 622 verifies the endpoint signature and the instruction signature corresponding to the given instruction, regardless of whether endpoint device 622 is able to verify the instruction signatures of other instructions in the endpoint-specific instruction payload. In other cases, the given instruction may be executed when endpoint device 622 verifies the endpoint signature and the instruction signatures of all instructions in the endpoint-specific instruction payload (i.e., when no portion of the endpoint-specific instruction payload has been tampered with).

Based on and/or in response to execution of the one or more instructions at block 830, endpoint device 620 may be configured to provide, to multi-party server 612, one or more outputs of one or more operations that correspond to the one or more instructions, as indicated by arrow 832. In some cases, the one or more outputs may represent information that computational instance intended to obtain from endpoint device 622 by transmitting the instruction(s) in the shared instruction payload to endpoint device 622 by way of multi-party server 612. Based on and/or in response to reception of the one or more outputs at arrow 832, multi-party server 612 may be configured to provide the one or more outputs to computational instance 322, as indicated by arrow 834.

In some cases, the operations of block 820 through arrow 834 may be repeated one or more times, as indicated by arrow 836. For example, computational instance 322 may use the one or more outputs to determine one or more additional instructions to be executed by endpoint device 622. Each of the one or more additional instructions may be cryptographically signed by computational instance 322 and verified by endpoint device 622 as discussed above, thus protecting the one or more additional instructions from tampering.

### X. Example Operations

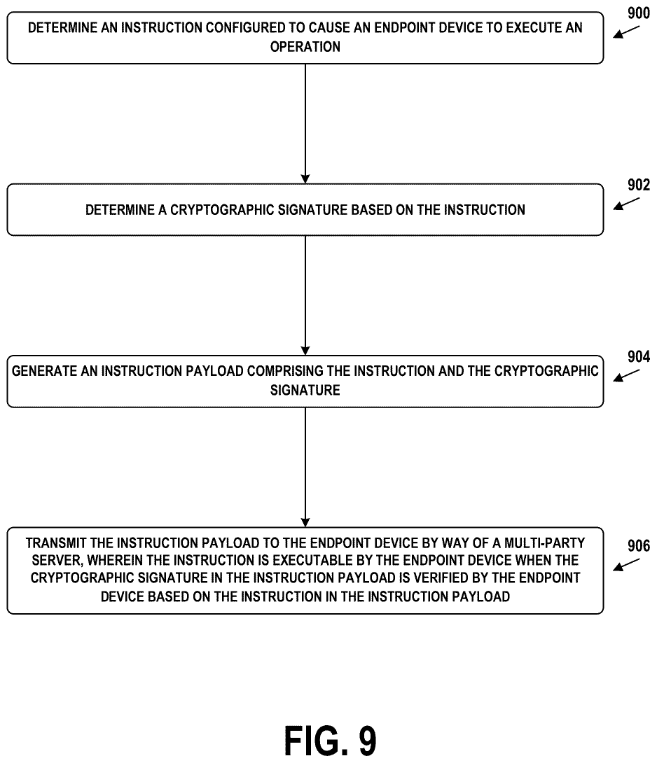

FIG. 9 is a flow chart illustrating an example embodiment. The process illustrated by FIG. 9 may be carried out by a computing device, such as computing device 100, and/or a cluster of computing devices, such as server cluster 200. However, the process can be carried out by other types of devices or device subsystems. For example, the process could be carried out by a computational instance of a remote network management platform.

The embodiments of FIG. 9 may be simplified by the removal of any one or more of the features shown therein. Further, these embodiments may be combined with features, aspects, and/or implementations of any of the previous figures or otherwise described herein.

Block 900 may involve determining an instruction configured to cause an endpoint device to execute an operation. The instruction may allow, for example, a computational instance to remotely control aspects of the endpoint device.

Block 902 may involve determining a cryptographic signature based on the instruction.

Block 904 may involve generating an instruction payload that includes the instruction and the cryptographic signature. Inclusion of the cryptographic signature in the instruction payload may allow the endpoint device to detect whether the instruction payload has been tampered with at any point during transmission to the endpoint device, thus improving the security of the instruction, the endpoint device, and/or the network to which the endpoint device belongs.

Block 906 may involve transmitting the instruction payload to the endpoint device by way of a multi-party server. The instruction may be executable by the endpoint device when the cryptographic signature in the instruction payload is verified by the endpoint device based on the instruction in the instruction payload. Verification of the cryptographic signature prior to execution of the instruction may prevent the endpoint device from executing any malicious instructions that may be introduced into the instruction payload after generation thereof.

In some examples, each of the instruction, the cryptographic signature, and the instruction payload may be determined by a single-party computational instance of a remote network management platform. The endpoint device may be configured to communicate with the single-party computational instance by way of the multi-party server.

In some examples, the cryptographic signature may be determined using a private key of the single-party computational instance. The cryptographic signature in the instruction payload may be verifiable by the endpoint device using a public key that corresponds to the private key and has been provided by the single-party computational instance to the endpoint device without transmission through the multi-party server.

In some examples, the single-party computational instance may be configured to transmit the instruction payload to the multi-party server through a message broker. Execution of the operation by the endpoint device may cause the endpoint device to generate output data. The endpoint device may be configured to transmit the output data to the message broker by way of the multi-party server. The single-party computational instance may be configured to obtain the output data from the message broker asynchronously with the transmission of the output data to the message broker by the endpoint device.

In some examples, determining the instruction may include determining a shared instruction list that includes one or more instructions that include the instruction and are assigned for execution by one or more endpoint devices that that include the endpoint device. Determining the instruction may also include determining, for each respective endpoint device of the one or more endpoint devices, a corresponding endpoint-specific instruction list that includes at least one identifier of at least one instruction from the shared instruction list assigned for execution by the respective endpoint device. Determining the cryptographic signature may include determining, for each respective instruction in the shared instruction list, a corresponding instruction signature based on the respective instruction. Determining the cryptographic signature may also include determining, for each respective endpoint device of the one or more endpoint devices, a corresponding endpoint signature based on the corresponding endpoint-specific instruction list. The at least one instruction in the corresponding endpoint-specific instruction list may be executable by the respective endpoint device when both the corresponding instruction signature and the corresponding endpoint signature in the instruction payload are verified by the endpoint device.

In some examples, the instruction as transmitted to the endpoint device by way of the multi-party server may be executable by the endpoint device when a corresponding identifier of the instruction is included in the corresponding endpoint-specific instruction list of the endpoint device.

In some examples, the one or more instruction of the shared instruction list may include a plurality of instruction. The one or more endpoint devices may include a plurality of endpoint devices. A first subset of the plurality of instruction may be assigned for execution by the endpoint device. A second subset of the plurality of instruction may be assigned for execution by another endpoint device of the plurality of endpoint devices. The second subset may be different from the first subset.

In some examples, the one or more instruction of the shared instruction list may include a plurality of instruction. The one or more endpoint devices may include a plurality of endpoint devices. The multi-party server may be configured to provide, to each respective endpoint device of the plurality of endpoint devices, (i) the corresponding endpoint-specific instruction list and (ii) a subset of the shared instruction list. The subset of the shared instruction list may include each instruction included in the corresponding endpoint-specific instruction list.

In some examples, the instruction payload may include (i) the shared instruction list, (ii) for each respective instruction in the shared instruction list, the corresponding instruction signature, (iii) the corresponding endpoint-specific instruction list for each respective endpoint device, and (iv) for each respective endpoint in the corresponding endpoint-specific instruction list, the corresponding endpoint signature.

In some examples, each of (i) the corresponding instruction signature of each respective instruction in the shared instruction list and (ii) the corresponding endpoint signature of each respective endpoint device of the one or more endpoint devices may be generated using a shared cryptographic key.

In some examples, the corresponding instruction signature of each respective instruction in the shared instruction list may be generated using a first cryptographic key. The corresponding endpoint signature of each respective endpoint device of the one or more endpoint devices may be generated using a second cryptographic key that differs from the first cryptographic key.

In some examples, the corresponding endpoint-specific instruction list for at least one respective endpoint device may include a first copy of an identifier of a particular instruction from the shared instruction list and a second copy of the identifier of the particular instruction. The first copy of the identifier may be associated with a first parameter value of a parameter for the particular instruction and the second copy of the identifier may be associated with a second parameter value of the parameter for the particular instruction. The second parameter value may be different from the first parameter value. Reception of the corresponding endpoint-specific instruction list may be configured to cause the at least one respective endpoint device to execute the particular instruction a first time using the first parameter value and a second time using the second parameter value.

In some examples, the instruction may be executable by the endpoint device when the cryptographic signature in the instruction payload is verified by the endpoint device by determining that the cryptographic signature matches a second cryptographic signature determinable by the endpoint device based on the instruction in the instruction payload.

In some examples, generating the instruction payload may include encrypting at least part of the instruction. The instruction may be executable by the endpoint device after decryption of the at least part of the instruction by the endpoint device.

In some examples, the multi-party server may be configured to, based on obtaining the instruction payload, determine an endpoint-specific instruction payload that includes the instruction, the cryptographic signature, and directions for obtaining, by the endpoint device, software code for executing the instruction.

In some examples, the operation may include an operating system function.

In some examples, the operation may include a function of a plug-in executable by the endpoint device.

In some examples, the operation may form part of a discovery pattern.

In some examples, the instruction may include a parameter value of a parameter to be used by the endpoint device in execution of the operation.

In some examples, prior to determining the instruction, a software application may be provided to the endpoint device. The software application may be configured to receive instruction payloads obtained from the multi-party server and may facilitate execution of instructions contained in the instruction payloads.

### XI. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
determining an instruction configured to cause an endpoint device to execute an operation;
determining a cryptographic signature based on the instruction;
generating an instruction payload comprising the instruction and the cryptographic signature; and
transmitting the instruction payload to the endpoint device by way of a multi-party server, wherein the instruction is executable by the endpoint device when the cryptographic signature in the instruction payload is verified by the endpoint device based on the instruction in the instruction payload.

2. The method of claim 1, wherein each of the instruction, the cryptographic signature, and the instruction payload is determined by a single-party computational instance of a remote network management platform, and wherein the endpoint device is configured to communicate with the single-party computational instance by way of the multi-party server.

3. The method of claim 2, wherein the cryptographic signature is determined using a private key of the single-party computational instance, and wherein the cryptographic signature in the instruction payload is verifiable by the endpoint device using a public key that corresponds to the private key and has been provided by the single-party computational instance to the endpoint device without transmission through the multi-party server.

4. The method of claim 2, wherein the single-party computational instance is configured to transmit the instruction payload to the multi-party server through a message broker, wherein execution of the operation by the endpoint device causes the endpoint device to generate output data, wherein the endpoint device is configured to transmit the output data to the message broker by way of the multi-party server, and wherein the single-party computational instance is configured to obtain the output data from the message broker asynchronously with the transmission of the output data to the message broker by the endpoint device.

5. The method of claim 1, wherein:
determining the instruction comprises:
determining a shared instruction list comprising one or more instructions that comprise the instruction and are assigned for execution by one or more endpoint devices that comprise the endpoint device;
determining, for each respective endpoint device of the one or more endpoint devices, a corresponding endpoint-specific instruction list comprising at least one identifier of at least one instruction from the shared instruction list assigned for execution by the respective endpoint device;
determining the cryptographic signature comprises:
determining, for each respective instruction in the shared instruction list, a corresponding instruction signature based on the respective instruction; and
determining, for each respective endpoint device of the one or more endpoint devices, a corresponding endpoint signature based on the corresponding endpoint-specific instruction list, wherein the at least one instruction in the corresponding endpoint-specific instruction list is executable by the respective endpoint device when both the corresponding instruction signature and the corresponding endpoint signature in the instruction payload are verified by the endpoint device.

6. The method of claim 5, wherein the instruction as transmitted to the endpoint device by way of the multi-party server is executable by the endpoint device when a corresponding identifier of the instruction is included in the corresponding endpoint-specific instruction list of the endpoint device.

7. The method of claim 5, wherein the one or more instructions of the shared instruction list comprise a plurality of instructions, wherein the one or more endpoint devices comprise a plurality of endpoint devices, wherein a first subset of the plurality of instructions is assigned for execution by the endpoint device, wherein a second subset of the plurality of instructions is assigned for execution by another endpoint device of the plurality of endpoint devices, and wherein the second subset is different from the first subset.

8. The method of claim 5, wherein the one or more instructions of the shared instruction list comprise a plurality of instructions, wherein the one or more endpoint devices comprise a plurality of endpoint devices, wherein the multi-party server is configured to provide, to each respective endpoint device of the plurality of endpoint devices, (i) the corresponding endpoint-specific instruction list and (ii) a subset of the shared instruction list, wherein the subset of the shared instruction list comprises each operation included in the corresponding endpoint-specific instruction list.

9. The method of claim 5, wherein the instruction payload comprises (i) the shared instruction list (ii), for each respective instruction in the shared instruction list, the corresponding instruction signature, (iii) the corresponding endpoint-specific instruction list for each respective endpoint device, and (iv), for each respective endpoint in the corresponding endpoint-specific instruction list, the corresponding endpoint signature.

10. The method of claim 5, wherein each of (i) the corresponding instruction signature of each respective instruction in the shared instruction list and (ii) the corresponding endpoint signature of each respective endpoint device of the one or more endpoint devices is generated using a shared cryptographic key.

11. The method of claim 5, wherein the corresponding instruction signature of each respective instruction in the shared instruction list is generated using a first cryptographic key, and wherein the corresponding endpoint signature of each respective endpoint device of the one or more endpoint devices is generated using a second cryptographic key that differs from the first cryptographic key.

12. The method of claim 5, wherein the corresponding endpoint-specific instruction list for at least one respective endpoint device comprises a first copy of an identifier of a particular instruction from the shared instruction list and a second copy of the identifier of the particular instruction, wherein the first copy of the identifier is associated with a first parameter value of a parameter for the particular instruction and the second copy of the identifier is associated with a second parameter value of the parameter for the particular instruction, wherein the second parameter value is different from the first parameter value, and wherein reception of the corresponding endpoint-specific instruction list is configured to cause the at least one respective endpoint device to execute the particular instruction a first time using the first parameter value and a second time using the second parameter value.

13. The method of claim 1, wherein the instruction is executable by the endpoint device when the cryptographic signature in the instruction payload is verified by the endpoint device by determining that the cryptographic signature matches a second cryptographic signature determinable by the endpoint device based on the instruction in the instruction payload.

14. The method of claim 1, wherein generating the instruction payload comprises:
encrypting at least part of the instruction, wherein the instruction is executable by the endpoint device after decryption of the at least part of the instruction by the endpoint device.

15. The method of claim 1, wherein, based on obtaining the instruction payload, the multi-party server is configured to determine an endpoint-specific instruction payload that includes the instruction, the cryptographic signature, and directions for obtaining, by the endpoint device, software code for executing the instruction.

16. The method of claim 1, wherein:
the operation comprises an operating system function;
the operation comprises a function of a plug-in executable by the endpoint device; or
the operation forms part of a discovery pattern.

17. The method of claim 1, wherein the instruction comprises a parameter value of a parameter to be used by the endpoint device in execution of the operation.

18. The method of claim 1, further comprising:
prior to determining the instruction, providing, to the endpoint device, a software application configured to receive instruction payloads obtained from the multi-party server and facilitate execution of instructions contained in the instruction payloads.

19. A non-transitory computer-readable medium, having stored thereon program instructions that, upon execution by a computing system, cause the computing system to perform operations comprising:
determining an instruction configured to cause an endpoint device to execute an operation;
determining a cryptographic signature based on the instruction;
generating an instruction payload comprising the instruction and the cryptographic signature; and
transmitting the instruction payload to the endpoint device by way of a multi-party server, wherein the instruction is executable by the endpoint device when the cryptographic signature in the instruction payload is verified by the endpoint device based on the instruction in the instruction payload.

20. A system comprising:
one or more processors; and
memory, containing program instructions that, upon execution by the one or more processors, cause the system to perform operations comprising:
determining an instruction configured to cause an endpoint device to execute an operation;
determining a cryptographic signature based on the instruction;
generating an instruction payload comprising the instruction and the cryptographic signature; and
transmitting the instruction payload to the endpoint device by way of a multi-party server, wherein the instruction is executable by the endpoint device when the cryptographic signature in the instruction payload is verified by the endpoint device based on the instruction in the instruction payload.
